(19) United States
(12) Patent Application Publication
(10) Pub. No.: US 2014/0129342 A1
(43) Pub. Date: May 8, 2014

(54) DYNAMICALLY ADJUSTING INVITATIONAL CONTENT PLACEMENT OPPORTUNITIES IN INTERACTIVE ENVIRONMENTS

(71) Applicant: APPLE INC., Cupertino, CA (US)

(72) Inventors: Mehul K. Sanghavi, Sunnyvale, CA (US); Michael Froimowitz Greenzeiger, Sunnyvale, CA (US); Ravindra Phulari, San Jose, CA (US)

(73) Assignee: Apple Inc., Cupertino, CA (US)

(21) Appl. No.: 13/670,272

(22) Filed: Nov. 6, 2012

(51) Int. Cl. G06Q 30/02

(52) U.S. Cl. 705/14.66; 705/14.4; 705/14.69

(57) ABSTRACT

A potential source of revenue for the developer of an interactive environment can be to offer sponsorship opportunities within the interactive environment. These sponsorship opportunities can take the form of sponsoring virtual placement items within the interactive environment by displaying invitational content in conjunction with a virtual placement item. The sponsored placement opportunities can be pre-defined. However, to improve the success of the invitational content, the placement opportunities can be adjusted in real-time based on one or more invitational content placement rules. Additionally, each placement opportunity can specify one or more virtual placement item characteristics from a virtual placement item classification hierarchy. A virtual placement item classification hierarchy can be a semantic hierarchy specifying various characteristics for virtual placement items where the characteristics have telescoping specificity. The classification hierarchy can be used to aid in selecting invitational content for a placement opportunity and in determining a cost of the placement.

### BACKGROUND

1. Technical Field

The present disclosure relates to presenting invitational content and more specifically to dynamically adjusting the placement opportunities for invitational content in interactive environments.

2. Introduction

Interactive environments, such as virtual worlds, electronic games, and augmented reality, are all made up of a variety of virtual placement items that define an environment. The virtual placement items can be background items that define the environment, such as buildings, billboards, furniture, automobiles, consumer electronics, etc., or they can be items that characters actively engage with in the interactive environment, such as virtual goods that can be purchased with virtual currency, like food, drink, clothing, books, consumer electronics, cars, etc. A common source of revenue for the creators of interactive environments is to offer opportunities to sponsor virtual placement items within the interactive environment. For example, a soda company can sponsor a soda can within the interactive environment so that the soda can bears the logo of the soda company. In another example, a car company can sponsor a car in a car racing game so that instead of the car being a generic car, it can be a car produced by the car company.

Virtual placement item sponsorships not only provide revenue opportunities for the interactive environment creator, but they also provide new opportunities for producers of goods and services to promote their products in a way that can be less intrusive than traditional multimedia advertising. That is, instead of disrupting playback of a multimedia item with banner advertisements or advertisement breaks, invitational content related to the goods and services can be placed along side other virtual placement items in the interactive environment. However, current sponsorship opportunities are often inflexible or static. For example, the same sponsored props are presented to all users who interact with a sponsored item. Additionally, the sponsorship opportunities are often fixed in number, placement, type, and/or duration due to constraints on the availability of virtual placement items. The current constraints placed on virtual placement item sponsorship opportunities decreases the benefits available to interactive environment creators, invitational content providers, and users of the interactive environments, alike.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for presenting invitational content within an interactive environment. An interactive environment can be any electronic environment in which one or more users can interact with other users and/or virtual placement items. At some point during the execution of the interactive environment, a set of invitational content placement opportunities can be determined. The placement opportunities can correspond to a view of the interactive environment, such as a 360 degree view of a room in the interactive environment. To determine the placement opportunities one or more invitational content placement rules related to the interactive environment can be applied. The rules can be applied to adjust a pre-defined set of invitational content placement opportunities.

In some embodiments, the one or more invitational content placement rules can be applied in real-time, such as in response to a request for an invitational content virtual placement item during the execution of the interactive environment. Additionally, the one or more invitational content placement rules can be applied proactively in order to project placement opportunities prior to a user entering a next view of the interactive environment.

The rules can cause a variety of changes to the set of placement opportunities. The adjustments can include a change in the number of placement opportunities, the location of a placement opportunity, the duration of a placement opportunity, the placement characteristics specified in a placement opportunity, the cost of a placement opportunity, and/or any other property of a placement opportunity and/or the set of placement opportunities.

An invitational content placement rule can increase the number of placement opportunities, which can result in an increase in the number of virtual placement items presented in the interactive environment. The increase can be in response to detecting that a number of users engaged with the interactive environment is greater than a pre-defined threshold number of users. The increase can also be in response to detecting that the number of users engaged with the interactive environment has simply increased.

An invitational content placement rule can also cause an adjustment to the set of placement opportunities based on an interaction history for the interactive environment. In some cases, the interaction history can include a navigation history across all or at least a subset of the users of the interactive environment. Alternatively, the interaction history can be specific to a user or an instantiation of the interactive environment.

A placement opportunity can specify one or more placement characteristics that can be used to aid in selecting an invitational content item to present in conjunction with a virtual placement item. The placement characteristics can include virtual placement item characteristics that describe the virtual placement item at the placement opportunity. The placement characteristics can also include target user characteristics, such as channel characteristics, demographic characteristics, behavioral characteristics, spatial-temporal characteristics, and avatar characteristics. A placement opportunity can further specify other values related the display of an invitational content virtual placement item, such as duration of display.

In some embodiments, the specified virtual placement item characteristics can be characteristics in one or more virtual placement item classification hierarchies. A virtual placement item classification hierarchy can define a relationship between a set of virtual placement item characteristics, where a characteristic lower in the virtual placement item classification hierarchy has a greater specificity than an item higher in the virtual placement item classification hierarchy on the same branch. A virtual placement item classification hierarchy can be universal or specific to one or more interactive environments.

A virtual placement item classification hierarchy can serve a number of functions. In some cases, the classification hierarchy can be used to aid in identifying one or more candidate invitational content items by matching invitational content items with the specified virtual placement item characteristics. The classification can also be used in determining a cost for a placement opportunity. The cost of a placement opportunity can be at least partially based on a cost assigned to the characteristic in the hierarchy. In some cases, a cost can be lower when the invitational content placement opportunity specifies a virtual placement item characteristic lower in the classification hierarchy.

The placement characteristics can also be classified as preferred or alternative. In some cases, an alternate characteristic can be used when an invitational content item cannot be found to match a preferred characteristic. The alternate characteristics can also be used for premium placement opportunities by allowing an invitational content provider to place content in a placement opportunity that typically would not be available for that invitational content.

Once at least one placement opportunity has been identified, at least one invitational content item can be selected for each identified placement opportunity. An invitational content item can be selected such that the specified one or more placement characteristics are satisfied.

An identified invitational content item can be presented in a placement opportunity in conjunction with a virtual placement item, such as by rendering an invitational content virtual placement item in the interactive environment on a client device. An invitational content item can be presented in conjunction with a virtual placement item by overlaying the invitational content item on a virtual placement item or embedding the invitational content item within the virtual placement item. In some cases, the overlay or embedding can require a change in the size and/or shape of the virtual placement item. Such a change can be automatically permitted or may only be permitted for premium placement opportunities. An invitational content item can also be presented in conjunction with a virtual placement item through a virtual placement item provided by an invitational content provider.

In the event that it is not possible to identify a suitable item of invitational content for a placement opportunity, a generic virtual placement item, or the virtual placement item that already existed in the interactive environment can be presented.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary configuration of devices and a network;

FIG. 2 illustrates a first exemplary virtual placement item classification hierarchy;

FIG. 3 illustrates a second exemplary virtual placement item classification hierarchy;

FIG. 4 illustrates an exemplary method for presenting invitational content in a interactive environment;

FIG. 5 illustrates an exemplary method for delivery invitational content for presentation in an interactive environment; and

FIG. 6 illustrates an exemplary system configuration.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The present disclosure addresses the need in the art for an improved way to present invitational content within interactive environments. An interactive environment can be any electronic environment in which one or more users can interact with other users and/or virtual placement items. For example, an interactive environment can be an interactive three-dimensional interactive environment in which users take the form of avatars to interact with the interactive environment. A classic form of interactive environments is electronic games, which can range from simple single player games to complex massively multiplayer online games (MMOGs). A person skilled in the relevant art will recognize that while the disclosure frequently uses electronic games to illustrate the presently disclosed technology, an interactive environment can be any electronically enhanced environment without parting from the spirit and scope of the disclosure. For example, an interactive environment within the context of the presently disclosed technology can be augmented reality in which a view of a physical, real-world environment is augmented with virtual placement items.

Regardless of the complexity of an interactive environment, the interactive environment can include one or more virtual placement items, such as a virtual prop. A virtual placement item can be a virtual representation of any object found in the real world, or even objects not available in the real world. For example, a virtual placement item can be a background object that helps define the environment, such as a building, billboard, piece of furniture, motor vehicle, electronic device, etc. Alternatively, the virtual placement item can be an object that characters actively engage with in the interactive environment. For example, virtual goods that can be purchased with virtual currency, like food, drink, clothing, books, consumer electronics, etc.

A virtual placement item can be persistent, limited duration, and/or limited quantity. A persistent virtual placement item can be a virtual placement item that exists in the interactive environment for an unlimited duration. That is, a persistent virtual placement item can reoccur in each instantiation of the interactive environment, thus exposing the user to the virtual placement item an unlimited number of times. However, a persistent virtual placement item can also be restricted to an instantiation of the interactive environment. That is, the virtual placement item can exist during a single playback of the interactive environment, such as a single game play, but once the interactive environment is restarted, such as upon restarting an electronic game, the virtual placement item can be replaced with a different virtual placement item.

A limited duration virtual placement item can be a virtual placement item that is available for a limited period of time. For example, a limited duration virtual placement item can be a special object available during a defined period of time, such as virtual placement item that corresponds to a particular holiday period. In some cases, a persistent duration virtual placement item can be converted to a limited duration virtual placement item. For example, a user action on a persistent duration virtual placement item can cause it to have a limited duration. In some cases, a limited duration virtual placement item can remain in existence in the interactive environment beyond the defined period of time, for example, if a user has acquired the virtual placement item. However, some limited duration virtual placement items can expire even if acquired by a user. In some cases, the duration can be based on time, use, or both.

A limited quantity virtual placement item can be a virtual placement item that is available in limited quantities. Once the pre-defined quantity has been distributed, additional copies or instantiations of the virtual placement item are no longer available. For example, a limited quantity virtual placement item can be a limited edition object that is available at a premium. If the limited edition object was widely available the desire to acquire the object may decrease, thereby decreasing its effectiveness to the interactive environment provider. In another example, a limited quantity virtual placement item can be a virtual placement item that provides a particular advantage in the interactive environment. If the virtual placement item was widely available the virtual placement item may no longer provide the desired objective.

A potential source of revenue for the provider of an interactive environment can be to offer sponsorship opportunities within the interactive environment. A sponsorship opportunity can take the form of sponsoring a virtual placement item. That is, an invitational content provider can have their invitational content item displayed in conjunction with a virtual placement item. For example, a soda company can sponsor a soda can within the interactive environment so that the soda can bears the logo of the soda company. In another example, a car company can sponsor a car in a car racing game so that instead of the car being a generic car, it can be a car produced by the car company.

The invitational content can be displayed in conjunction with a previously existing virtual placement item or the sponsored virtual placement item can be added to the interactive environment specifically for the sponsorship. For example, invitational content can be presented in conjunction with an existing billboard. In another example, the invitational content can be the virtual placement item, such as a particular make and model of a laptop, and the invitational content virtual placement item can be placed on a table in what would normally be an empty spot.

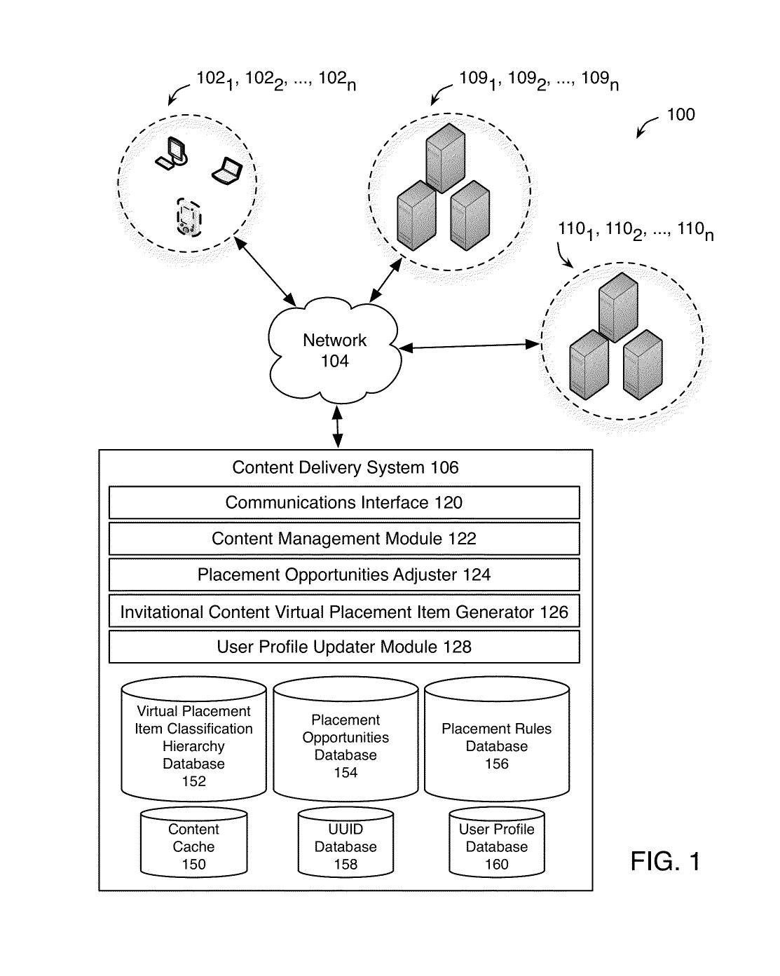

Using the presently disclosed technology it is possible to improve invitational content delivery through the use of dynamic placement opportunities within an interactive environment. That is, the determination as to where to place invitational content within an interactive environment can be adjusted in real-time based on one or more invitational content placement rules. An exemplary system configuration 100 for presenting invitational content within an interactive environment is illustrated in FIG. 1 wherein electronic devices communicate via a network for purposes of exchanging content and other data. The system can be configured for use on a wide area network, such as that illustrated in FIG. 1. However, the present principles are applicable to a wide variety of network configurations that facilitate the intercommunication of electronic devices. For example, each of the components of system 100 in FIG. 1 can be implemented in a localized or distributed fashion in a network.

In system 100, invitational content can be delivered to user terminals 102₁, 102₂, . . . , 102ₙ (collectively “102”) connected to a network 104 by direct and/or indirect communications with a content delivery system 106. Each of user terminals 102 can be configured to render an interactive environment that includes virtual placement items. User terminals 102 can be any network enabled client devices capable of receiving a content package and displaying a user interface, such as desktop computers; mobile computers; handheld communications devices, e.g. mobile phones, smart phones, tablets; smart televisions; set-top boxes; and/or any other network enabled computing devices. Furthermore, content delivery system 106 can concurrently accept connections from and interact with multiple user terminals 102.

The content delivery system 106 can receive a request for electronic content, such as an interactive environment, a virtual placement item, an invitational content item, etc., from one of user terminals 102. Thereafter, the content delivery system 106 can assemble a content package and transmit the assembled content page to the requesting one of user terminals 102. To facilitate communications with the user terminals 102 and/or any other device or component, the content delivery system 106 can include a communications interface 120.

The content delivery system 106 can include a content management module 122 to facilitate the generation of an assembled content package. Specifically, the content management module 122 can combine content from one or more primary content providers 109₁, 109₂, . . . , 109ₙ (collectively “109”) and content from one or more secondary content providers 110₁, 110₂, . . . 110ₙ (collectively “110”) to generate the assembled content package for the user terminals 102. For example, in the case of an interactive environment, the content management module 122 can be configured to assemble a content package by requesting the data, such as a virtual placement item, for the interactive environment from one of primary content providers 109 maintaining the interactive environment. For the invitational content in the interactive environment provided by the secondary content providers 110, the content management module 122 can request the appropriate data according to the arrangement between the primary and secondary content providers 109 and 110. Additionally, the content management module 122 can create content packages that contain content from a single content provider. That is, a content package can contain only primary content or a content package can contain only secondary content. For example, a content package can be an invitational content virtual placement item provided by a secondary content provider 110. However, the content package is not limited to the content from content providers 109 and 110. Rather, the content package can include other data generated at the content delivery system 106. In some embodiments, the content delivery system 106 can preselect the content package before a request is received. For example, the content delivery system 106 can pre-assemble an invitational content virtual placement item by overlaying an invitational content item from a secondary content provider 110 on a virtual placement item from a primary content provider 109. When a content package is required, the content delivery system 106 can select a pre-assembled invitational content virtual placement item that satisfies the request requirements.

An assembled content package can include text, graphics, audio, video, executable code, or any combination thereof. Further, an assembled content package can include invitational content designed to inform or elicit a pre-defined response from the user. In some embodiments, the invitational content can be associated with a product or can directly or indirectly advertise a product. For example, the assembled content package can include one or more types of advertisements from one or more advertisers.

Additionally, the invitational content can be active invitational content. That is, invitational content that is designed to primarily elicit a pre-defined response from a user. For example, active invitational content can include one or more types of advertisements configured to be clicked upon, solicit information, or be converted by the user into a further action, such as a purchase or a download of the advertised item. However, invitational content can also be passive invitational content. That is invitational content that is designed to primarily inform the user, such as a video. In some cases, passive invitational content can include information that can lead or direct users to other invitational content including active invitational content.

Furthermore, the invitational content can be dynamic invitational content. That is invitational content that varies over time or that varies based on user interaction. For example, dynamic invitational content can include an interactive game. However, the various embodiments are not limited in this regard and the invitational content can include static invitational content that neither varies over time nor with user interaction. In the various embodiments, invitational content in a content package can be static or dynamic and active or passive. A content package can include a combination of various types of invitational content in a single content package.

In some cases, a content package can replace or update invitational content in a content package already delivered to a user terminal. For example, a first content package can include an app, such as an electronic game, that can be installed on the user terminal 102. A subsequent content package can include one or more items of invitational content that can be presented to a user of the user terminal 102 while the user interacts with the app.

Although primary and secondary providers 109 and 110 are presented herein as separate entities, this is for illustrative purposes only. In some cases, the primary and the secondary content providers 109 and 110 can be the same entity. Thus, a single entity can provide both the primary and the secondary content.

The content management module 122 can be configured to request that content be sent directly from content providers 109 and 110. Alternatively, a cached arrangement can also be used to improve performance of the content delivery system 106 and improve overall user experience. That is, the content delivery system 106 can include a content database 150 for locally storing/caching content maintained by content providers 109 and 110. The data in the content database 150 can be refreshed or updated on a regular basis to ensure that the content in the database 150 is up to date at the time of a request from a user terminal 102. However, in some cases, the content management module 122 can be configured to retrieve content directly from content providers 109 and 110, such as if the data in the content database 150 appears to be outdated or corrupted.

Secondary content providers 110 can potentially sponsor each virtual placement item within the interactive environment through invitational content placement opportunities. A placement opportunity can correspond to a location and/or virtual placement item within an interactive environment. For example, a placement opportunity can be an object, such as a can of soda. An invitational content item can then be applied to the object, such as by applying a label to the soda can. In another example, a placement opportunity can be the top of a desk. In this case, an invitational content item can be a virtual placement item, such as an object placed on the desk, e.g. a particular type of laptop computer.

The duration of an invitational content sponsorship can vary based on the configuration of the system, the sponsorship agreement, and/or the type of virtual placement item, e.g. persistent, limited duration, and/or limited quantity. For example, a sponsorship of a limited duration virtual placement item may be for the full duration of the virtual placement item's existence. In another example, a sponsorship of a persistent virtual placement item may be limited to a defined period of time or for a particular instantiation of the virtual placement item, e.g. a different invitational content item can be displayed in conjunction with a virtual placement item each time a user encounters the virtual placement item at a particular location. For example, a billboard could display a different invitational content item each time the billboard is displayed or a car in a racing game can be of a different make or model for different races of the same course. Other sponsorship durations are also possible.

A placement opportunity can also include one or more placement characteristics that can be used to aid in selecting an invitational content item for the placement opportunity. Placement characteristics can include virtual placement item characteristics that can describe the virtual placement item at the placement opportunity. For example, a virtual placement item characteristic can indicate a size, shape, color, or even whether the virtual placement item is moveable and/or animated. Virtual placement item characteristics can be general, such as size, shape, or color, or the characteristics can be of varying degrees of specificity, such as consumer electronic device, computer, laptop computer, or a particular model of laptop computer. In some cases, the virtual placement item characteristics can be universal and apply to any interactive environment. However, the virtual placement item characteristics can also be specific to one or more interactive environments. For example, a virtual placement item characteristic can specify a theme for an interactive environment, such as medieval, space, science fiction, urban, etc.

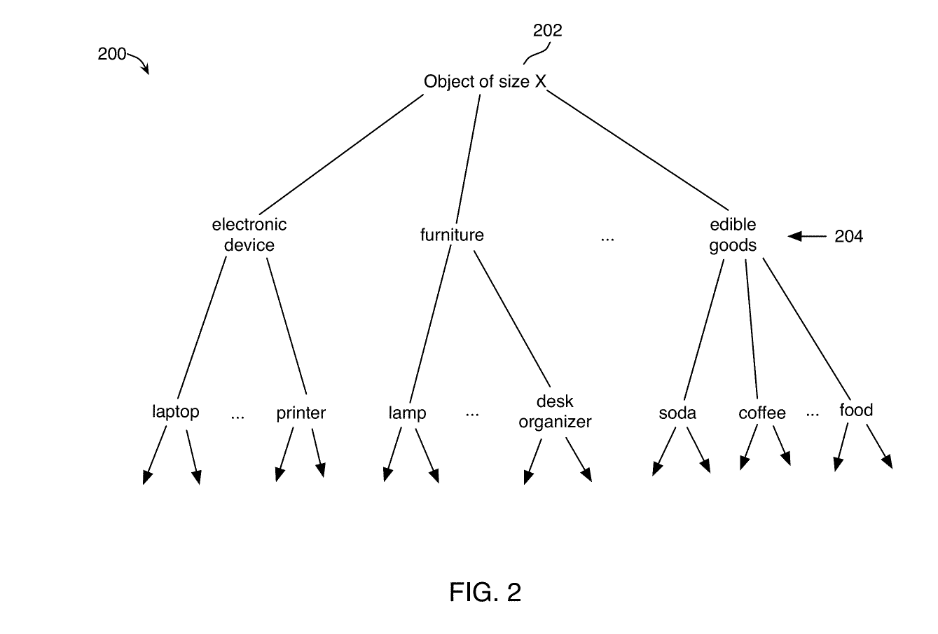

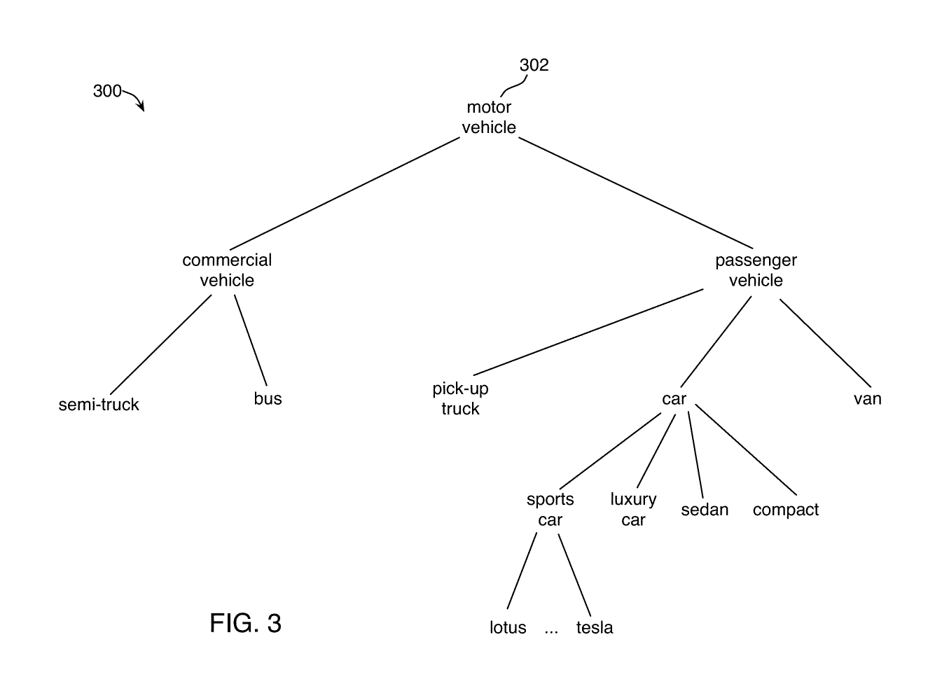

In some embodiments, the virtual placement item characteristics can be linked to one or more virtual placement item classification hierarchies. A virtual placement item classification hierarchy can be a semantic hierarchy specifying various characteristics for virtual placement items where the characteristics have telescoping specificity. That is, a virtual placement item classification hierarchy can define a relationship between a set of virtual placement item characteristics where a characteristic lower in the classification hierarchy has a greater specificity than an item higher in the classification hierarchy on the same branch. A virtual placement item classification hierarchy can be defined with any level of granularity and can start with any level of specificity. FIGS. 2 and 3 illustrate two examples of virtual placement item classification hierarchies. The hierarchy 200 in FIG. 2 has as its root 202 a very general virtual placement item characteristic: “Object of size X.” The children 204 of root 202 have a greater degree of specificity, and the increased specialization continues down the hierarchy. In contrast, the hierarchy 300 in FIG. 3 has as its root 302 a virtual placement item characteristic of “motor vehicle,” which is slightly more specific than root 202 in FIG. 2. As with hierarchy 200 in FIG. 2, the virtual placement item characteristics in hierarchy 300 also increase in specificity as the characteristics increase in distance from the root 302. However, characteristics at a same distance from the root, e.g. on the same level, do not necessarily have to have a same degree of specificity. That is, the telescoping specificity applies along branches, e.g. motor vehicle→passenger vehicle→car→sports car→lotus, and not necessarily across levels, e.g. semi-trucks, bus, pick-up truck, car, van.

As with virtual placement item characteristics, virtual placement item classification hierarchies can be universal or specific to one or more interactive environments. For example, hierarchy 200 in FIG. 2 may be a universal hierarchy that can be used to specify virtual placement item characteristics for any placement opportunity in any interactive environment, while hierarchy 300 in FIG. 3 may be specific to interactive environments focused on cars or urban environments. Furthermore, in some cases, an interactive environment provider can define a virtual placement item classification hierarchy that can only be used for the interactive environment provided by the interactive environment provider.

A virtual placement item classification hierarchy can be static, dynamic, or both. A static classification hierarchy can be configured to define a fixed relationship between a set of characteristics. That is, the relationship and the set of characteristics remain the same regardless of the current state of the interactive environment. Alternatively, a dynamic classification hierarchy can be configured such that the set of characteristics and/or the relationship between the characteristics can evolve or change based on the state of interactive environment. For example, as a user moves through the interactive environment the virtual placement item classification hierarchy may change. In another example, if the interactive environment includes a time travel feature, as the user travels through time the characteristics in the classification hierarchy can evolve to correspond to the current time period.

In some configurations, a virtual placement item classification hierarchy can be used to aid in determining a cost for a placement opportunity. For example, the more specific a characteristic, the less items that match the characteristic, therefore the cost can be cheaper than for a characteristic higher on a same branch in the virtual placement item classification hierarchy. A classification hierarchy can be designed such that two items at a same level in the hierarchy have a different level of specificity. In such a hierarchy, the two items can have different prices. That is, the level in the hierarchy does not necessarily dictate the cost. Other factors, such as the size, prominence, number of placements, and/or duration of display of the virtual placement item can also be used in determining a cost for a placement opportunity. Additionally, a cost model can be based on price offered by one or more content providers. For example, in a bid-based pricing model, a bid price can be used in place of, or on addition to, a cost based on position in the hierarchy.

When a placement opportunity specifies a characteristic in a virtual placement item classification, a candidate invitational content item can be an item that matches the specified characteristic. Additionally, a candidate invitational content item can match any characteristics lower in the hierarchy but on the same branch as the specific placement characteristics. For example, using the classification hierarchy from FIG. 3, suppose the placement opportunity specified the placement characteristic of car. With this placement characteristic, an invitational content item that matches, car or any of the sub-characteristics, such as luxury car or tesla, would be considered a candidate for the placement opportunity. In some cases, which of multiple candidate invitational content items is selected for a placement opportunity can be based at least in part on which is a closer match to the specified placement characteristic. For example, returning to our example, an invitational content item matched to luxury car can be selected over an invitational content item that matches tesla.

Referring back to FIG. 1, the content delivery system 106 can also include a virtual placement item classification hierarchy database 152 for locally storing/caching virtual placement item classification hierarchies. The data in the virtual placement item classification hierarchy database 152 can be refreshed or updated on a regular basis to ensure that the content in the database 152 is up to date at the time of a request from a user terminal 102. However, in some cases, the content management module 122 can be configured to retrieve one or more virtual placement item classification hierarchies directly from content providers 109 and/or 110.

The placement characteristics specified in a placement opportunity can also include target user characteristics. As used herein, the term “user characteristics” refers to the characteristics of a particular user associated with one or more of user terminals 102. User characteristics can include channel characteristics, demographic characteristics, behavioral characteristics, spatial-temporal characteristics, and avatar characteristics. Channel characteristics can define the specific delivery channel being used to deliver a content package to a user. For example, channel characteristics can include a type of electronic content, a type of device or user terminal, a carrier or network provider, or any other characteristic that defines a specific delivery channel for the content package. Spatial-temporal characteristics can define a location, a location zone, a date, a time, or any other characteristic that defines a geographic location and/or a time for delivery of the content package. Demographic characteristics can define characteristics of the users targeted by the content or associated with the content. For example, demographic characteristics can include age, income, ethnicity, gender, occupation, or any other user characteristics. Avatar characteristics can define characteristics of one or more avatars used by the user in one or more interactive environments. Avatar characteristics can include characteristics such as age, gender, special powers, interests, experience level, acquired virtual placement items, or any other characteristics relevant to an avatar. Behavioral characteristics can define user behaviors for one or more different types of content, separately or in combination with any other user characteristics. That is, different behavioral characteristics may be associated with different channel, demographic, spatial-temporal characteristics, or avatar characteristics. User characteristics can also include characteristics descriptive of a user's state of mind including characteristics indicative of how likely a user is to click on or convert an item of invitational content if it were displayed to the user. User characteristics can be learned directly or derived indirectly from a variety of sources. In some embodiments, the user characteristic values can be collected from one or more databases. For example, if the user is registered with an online media service, such as the ITUNES store maintained by Apple Inc. of Cupertino, Calif., the collected data could include the user's registration information. Such data can provide values for declared user characteristics. Furthermore, the content delivery system 106 can be configured to learn of or derive user characteristics from any number of other information sources. For example, in some configurations, the content delivery system 106 can derive or infer one or more user characteristic values from user characteristic values already known about the user.

In some configurations, a placement opportunity can include preferred and alternate placement characteristics. For example, a preferred characteristic can correspond to a laptop placed on the top of a desk, while an alternate characteristic can correspond to a more generic consumer electronics device suitable for placement on a desk. The alternate characteristics can pertain to a different virtual placement item than the preferred characteristics. For example, the preferred characteristics could correspond to a soda can, while the alternate characteristics can correspond to a coffee mug. If the alternate characteristics are used, the coffee mug will be displayed instead of the soda can.

How and when alternate characteristics are used can vary with the configuration of the system. In some cases, the alternate characteristics can be used when an invitational content item cannot be found to match the preferred characteristics. Additionally, the alternate characteristics can be used for premium placement opportunities. For example, presenting an invitational content item by matching the alternate characteristics can cost a premium because it provides an invitational content provider with a placement opportunity not typically available.

In some embodiments, a placement opportunity can be associated with one or more targeted segments. A targeted segment can be viewed as defining a space or region in k-dimensional space, where each of the k dimensions is associated with one of a plurality of user characteristics. In the various embodiments, the k dimensions can include both orthogonal and non-orthogonal dimensions. That is, some of the k dimensions can overlap or can be related in some aspect.

Each interactive environment can include a pre-defined set of placement opportunities. The content delivery system 106 can include a placement opportunities database 154 for storing the pre-defined placement opportunities. The data in the placement opportunities database 154 can be refreshed or updated on a regular basis to ensure that the content in the database 154 is up to date at the time of a request from a user terminal 102. However, in some cases, the content management module 122 can be configured to retrieve one or more placement opportunities directly from a interactive environment content provider 109 or from a client device 102 requesting an invitational content item. Furthermore, in some cases, a request for invitational content can include a set of placement opportunities.

In order to improve the effectiveness of invitational content delivery, the invitational content placement opportunities can be adjusted in real-time, such as at the time of request. To perform the adjustment, the content delivery system 106 can include a placement opportunities adjuster module 124. The placement opportunities adjuster module 124 can apply one or more invitational content placement rules to adjust the number of placement opportunities, the location of a placement opportunity, the duration of a placement opportunity, the placement characteristics specified in the placement opportunity, the cost of a placement opportunity, and/or any other property of a placement opportunity and/or the set of placement opportunities. In some cases, the effect of adjusting the set of placement opportunities can be to alter the virtual placement items displayed in the virtual environment. For example, increasing the number of placement opportunities can correspond with increasing the number of virtual placement items. In some configurations, the one or more placement rules can be stored in the placement rules database 156.

The placement opportunities adjuster 124 can also be configured to apply the one or more invitational content placement rules proactively to project placement opportunities prior to a request. For example, a projection could be based on the possible next views in an interactive environment. Proactive application of the rules can enable the content delivery system 106 to prepare the invitational content items prior to a request. Such an approach may be necessary in situations where bandwidth constraints or latency cause a delay in a request or in delivering the invitational content virtual placement items, which can cause a disruption in the playback experience. Additionally, the placement opportunities adjuster 124 can further adjust the projected placement opportunities prior to identifying the set of placement opportunities to use.

An invitational content placement rule can be based on a business rule, an invitational content campaign goal or objective, an aspect or property of an interactive environment, a request by a content provider, and/or any other feature or property associated with presenting invitational content within a interactive environment. For example, an invitational content placement rule can specify that a number of placement opportunities should be increased when more users are engaged with the interactive environment. Therefore, the rule could be designed such that the pre-defined placement opportunities are used, but once the number of users engaged with the interactive environment reaches a threshold value, the number of placement opportunities can increase. In some cases, the increase can be based on the increase in the number of users, e.g. the increase can be linear or logarithmic. The increase can also be incremental, such as the placement opportunities increase by a set number for each subsequent user threshold value satisfied.

In another example, an invitational content placement rule can be based on an interaction history for the interactive environment. In some cases, the interaction history can be user specific, such as a user's navigation through the interactive environment or duration of time in the interactive environment. That is, the rule can cause a change in the placement opportunities based on the traffic patterns of the user or how long the user has been engaged with the interactive environment. The interaction history can also be across all users of the interactive environment. That is, the rule can be based on statistics or an analysis of user actions within the interactive environment. For example, consider a stage in an interactive environment where a user enters through a main door and can go either left or right. If the pre-defined set of placement opportunities were allocated evenly between left and right, but the statistics indicated that 70 percent of users went left, then applying the rule could result in an adjustment of the allocation of the placement opportunities between left and right. The rule could also result in increasing the number of placement opportunities on the left without decreasing the amount on the right or even adjusting the cost of a placement opportunity. The interaction history can also be specific to an instantiation of the interactive environment, such as a single playback of a game. In a further example, a placement rule can be designed to create premium placement opportunities at strategic locations or when certain conditions in the interactive environment are satisfied, such as a user achieves a high scorer status. Invitational content placement rules can also be based on other aspects of the system, such as campaigns booked, conversion rate, click-through rate, characteristics of any engaged users, skill level of any engaged users, etc.

A placement rule can also be based on a request or a bid from an invitational content provider. For example, an invitational content provider can provide a budget. If the budget is greater than the cost associated with the available placement opportunities, the number of placement opportunities can be increased to maximize the invitational content providers budget. In another example an invitational content provider can specify a desire to pay a premium for one or more placements if the number of placement opportunities is decreased. Other rules based upon cost per placements, budget, and/or cost per object are also possible.

The content delivery system 106 can include a predefined threshold value for the maximum number of placement opportunities that can be presented at a given time. The threshold value can be a single value valid across all interactive environments. The system can also include one or more specific threshold values that are defined for specific interactive environments. For example, each interactive environment can define a single maximum. In another example, multiple maximums can be defined for a single interactive environment where each maximum corresponds to a different set of circumstances, such as different levels, number of engaged users, traffic patterns, user interaction history, etc.

In some cases, an invitational content placement rule can be specific to an interactive environment, or even a particular portion, location, level, or aspect of the interactive environment. For example, a placement rule based on interaction history for the specific interactive environment. However, some invitational content placement rules can also be universal. That is, the placement rule can apply across interactive environments. For example, a placement rule based on campaigns booked. Additionally, in some cases, a placement rule can be specific to an invitational content provider.

An invitational content placement rule can also be specific to single-user or multi-user scenarios. For example, an interactive environment can have two invitational content rules that yield different placement opportunities. One rule can be applied when only a single user is engaged with the system, while the other rule can be applied when multiple users are engaged. In some cases, the multi-user rule can be applied when multiple users are engaged with the same view of the interactive environment. Alternatively, a multi-user rule can be designed to be applied when multiple user are engaged with any part of the interactive environment.

An invitational content placement rule can also be assigned a weight. The weight can be based on a variety of factors, such as whether a rule is based on avatar characteristics or characteristics of the actual user. When a weight is assigned, the weight can be used to determine which rules to apply. For example, when two rules are both eligible to be applied but they conflict, the rule with a higher weight can be applied. A weight can also be used as a scaling factor so that any changes to the placement opportunities are scaled based on the assigned weight.

The content delivery system 106 can also include an invitational content virtual placement item generator 126. The invitational content virtual placement item generator 126 can be configured to perform a number of different functionalities. The invitational content virtual placement item generator 126 can be configured to select an invitational content item for a placement opportunity. The invitational content item can be selected to satisfy the one or more placement characteristics. For example, if the placement characteristics specify a characteristic or index in a virtual placement item classification hierarchy, the invitational content virtual placement item generator 126 can identify one or more invitational content items that match the specified characteristic. In some cases, the invitational content prop generator 126 can be configured to identify invitational content items that match any characteristic on a same branch from the specified characteristic. That is, the matched characteristic can be of greater specificity than the specified characteristic. For example, the specified characteristic may be electronic device, but the matched characteristic is laptop computer.

In some cases, it may not be possible to identify a suitable invitational content item for a placement opportunity. In such a situation, the action taken can vary with the configuration of the system and/or the placement opportunity. In some cases, alternate characteristics specified in the placement opportunity can be used. However, if alternate characteristics are not available or still do not result in a match then a generic virtual placement item, or the virtual placement item that already existed in the interactive environment, can be displayed. For example, if the placement opportunity corresponded to a beverage container, a generic beverage can could be displayed. Alternatively, the system can be configured to not display a virtual placement item. For example, if the placement opportunity corresponds to a top of a desk, the top of the desk can remain empty.

In some cases, an identified invitational content item can be designed to be presented in conjunction with a virtual placement item. That is, the invitational content item can be overlaid on a number of different virtual placement items. For example, an invitational content item can be overlaid on a virtual placement item that already exists in the interactive environment. In this case, the merging of the invitational content item and the virtual placement item can occur on the client device, the content delivery system 106, and/or another computing device designed to deliver invitational content virtual placement items to the client device for rendering. To facilitate the merging on the content delivery system 106, the invitational content virtual placement item generator 126 can also be configured to generate an invitational content virtual placement item from a virtual placement item and an invitational content item, such as by embedding the invitational content item within the virtual placement item. For some combinations of virtual placement items and invitational content items, the merging may require a change in size and/or shape of the virtual placement item. The system can be configured to automatically permit such a change. However, a change in size and/or shape can also be prohibited or only allowed for premium sponsorship opportunities.

Alternatively, in some cases, the identified invitational content item can already be an invitational content virtual placement item. That is, the invitational content item does not require further merging with an already existing virtual placement item. In some cases, an invitational content provider, such as secondary content provider 110, can supply an invitational content virtual placement item. An invitational content virtual placement item can also be the result of pre-assembling virtual placement items. For example, a secondary content provider 110 can book a campaign in which the provided invitational content is only to be displayed in conjunction with certain pre-defined virtual placement items. In this case, the content delivery system 106 can pre-assemble the invitational content virtual placement items to improve the efficiency of delivering invitational content to an interactive environment.

In the various embodiments, the content delivery system 106 can also include a unique user identifier (UUID) database 158 that can be used for managing sessions with the various user terminal devices 102. The UUID database 158 can be used with a variety of session management techniques. For example, the content delivery system 106 can implement an HTTP cookie or any other conventional session management method (e.g., IP address tracking, URL query strings, hidden form fields, window name tracking, authentication methods, and local shared objects) for user terminals 102 connected to content delivery system 106 via a substantially persistent network session. However, other methods can be used as well. For example, in the case of handheld communications devices, e.g. mobile phones, smart phones, tablets, or other types of user terminals connecting using multiple or non-persistent network sessions, multiple requests for content from such devices may be assigned to a same entry in the UUID database 158. The content delivery system 106 can analyze the attributes of requesting devices to determine whether such requests can be attributed to the same device. Such attributes can include device or group-specific attributes.

In some embodiments, the content delivery system 106 can include a user-profile database 160. The user-profile database 160 can, at least in part, be constructed based on declared user characteristics related to one or more users. In some cases, the user-profile database may contain inferred or derived user characteristic values. The user-profile database 160 can be updated using a user-profile-updater module 128. In some embodiments, the user-profile-updater module 128 can be configured to add additional profile data, update profile data, fill in missing profile data, or infer user characteristic values from declared data.

In addition to the user characteristics previously described, the user profile database 160 can include information related to a user's interaction with one or more interactive environments. In some configurations, the interaction history can be included in the user characteristics, such as the behavioral characteristics. The interaction history can also be maintained as a separate aspect of a user profile. In some embodiments, the user's interaction history can be used with one or more invitational content placement rules to adjust the placement opportunities. For example, a user's interaction history can be used to award the user with premium placement opportunities, such as unique offers for being a high scorer. In another example, a user's interaction history can be used to decrease or increase the number of placement opportunities, or to reposition the placement opportunities.

The user-profile-updater module 128 can also be configured to maintain the user profile database 160 to include only more recently acquired data or to re-derive any inferred characteristics in order to ensure that the user profile is an accurate reflection of the current state of the user (location, state of mind, behaviors, demographics, etc. can change rapidly). For example, the user-profile-updater module 128 can be configured to maintain the user profile database 160 to include only data from the last two to three months. However, the user-profile-updater module 128 can be configured to adjust the data in the user profile database 160 to cover any span of time. In some instances the user-profile-updater module 128 can update the profile database 160 in real-time. Alternatively, the user-profile-updater module 128 can be configured to set an expiration period on a subset of the data in the user profile database 160. For example, a policy can specify that user declared data is maintained as long as the user account is active, but user characteristic values based on activities in an interactive environment expire after a specified period of time. In some cases, a user can set the expiration period. In some instances, the user-profile-updater module 128 can update the user profile database 160 at least every week, or every day. In some cases, the content delivery system 106 can receive a direct request to update one or more user profiles. The update request can come directly from the user's device or any other device capable of communicating with the content delivery system 106, such as other content delivery networks or websites. In some cases, the content delivery system 106 can receive an indirect request to update one or more user profiles. An indirect request can be the result of receiving new user characteristic values. An update request can occur at any time.

While the content delivery system 106 is presented with specific components, it should be understood by one skilled in the art, that the architectural configuration of system 106 is simply one possible configuration and that other configurations with more or less components are also possible. For example, instead of storing the pre-defined placement opportunities, they could be sent to the content delivery system 106 as part of the request for invitational content.

As described above, one aspect of the present technology is the gathering and use of data available from various sources to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, or any other identifying information.

The present disclosure recognizes that the use of such personal information data, in the present technology, can be used to the benefit of users. For example, the personal information data can be used to deliver targeted content that is of greater interest to the user. Accordingly, use of such personal information data enables calculated control of the delivered content. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publically available information.

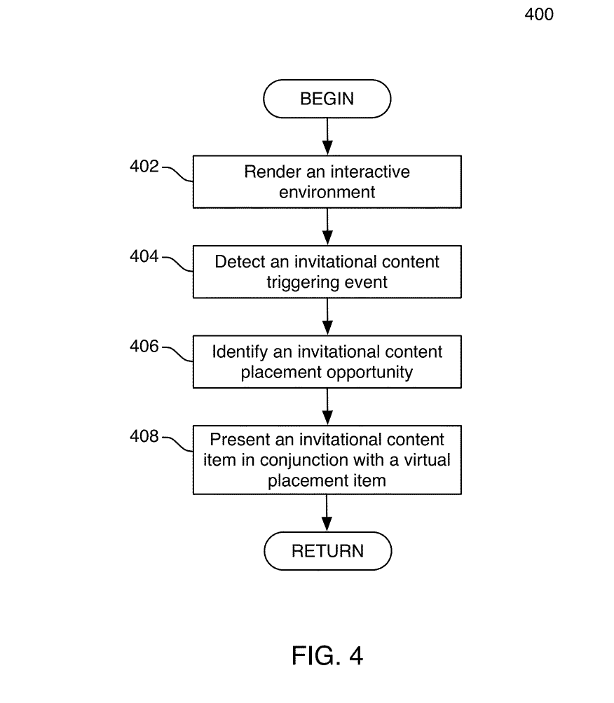

FIG. 4 is a flowchart illustrating steps in an exemplary method 400 for presenting invitational content in a interactive environment. For the sake of clarity, this method is discussed in terms of an exemplary system such as is shown in FIG. 1. Although, specific steps are shown in FIG. 4, in other embodiments a method can have more or less steps than shown.

The method 400 can begin when a client device 102 renders an interactive environment (402) for display to a user of the client device 102. At some point during playback of the interactive environment, the client device 102 can detect an invitational content triggering event (404). What constitutes an invitational content triggering event can vary with the configuration of the system and/or the interactive environment. In some cases, a triggering event can be the start of the interactive environment. However, a triggering event can also be entering a particular location in the interactive environment, accomplishing a particular achievement, interacting with the interactive environment for a predetermined period of time, encountering a particular virtual placement item, an action by the user, an action by another user, etc.

In response to detecting the invitational content triggering event, the client device 102 can identify an invitational content placement opportunity (406) within a view of an interactive environment. A view can correspond to a location of the user in the interactive environment. A view can be limited to the portion of the interactive environment that is currently active in a user interface presented to the user, e.g. that portion of the interactive environment rendered on a screen. However, a view can also include portions with a specified proximity of the actively presented content. For example, a 360 degree view of a room in an interactive environment can be a view.

The invitational content placement opportunity can specify an index or virtual placement item characteristic in a virtual placement item classification hierarchy. In some cases, the interactive environment running on the client device can include one or more pre-defined invitational content placement opportunities. Alternatively, the client device 102 can identify a placement opportunity by requesting an invitational content item from a content delivery system, such as content delivery system 106. In addition to the index or characteristic in the virtual placement item classification hierarchy, the placement opportunity can specify a duration to display the invitational content item and/or one or more target user characteristics. The one or more target user characteristics can be used to aid in selecting an invitational content item for the placement opportunity.

After identifying an invitational content placement opportunity, the client device 102 can present an invitational content item in conjunction with a virtual placement item (408) at the placement opportunity. Presenting an invitational content item can further require the client device 102 to request an invitational content item from the content delivery system 106. In some cases, the request can include the identified placement opportunity. The invitational content item can be selected, at least in part, based on the specified index or characteristic in the virtual placement item classification hierarchy. In some cases, the invitational content item selected can correspond to one or more alternate characteristics. The alternate characteristics can cause a change in virtual placement items and/or a change in the cost of the placement opportunity.

Presenting the invitational content item in conjunction with a virtual placement item can require the client device 102 to overlay the received invitational content item on a virtual placement item associated with the placement opportunity. Additionally, presenting the invitational content item can cause a change in size and/or shape of a virtual placement item. In some cases, the invitational content item received from the content delivery system 106 can be an invitational content virtual placement item, and thus presenting the invitational content item in conjunction with a virtual placement item simply requires the client device 102 to render the received invitational content item. After presenting the invitational content item in conjunction with the virtual placement item, the client device 102 can resume previous processing, which can include repeating method 400.

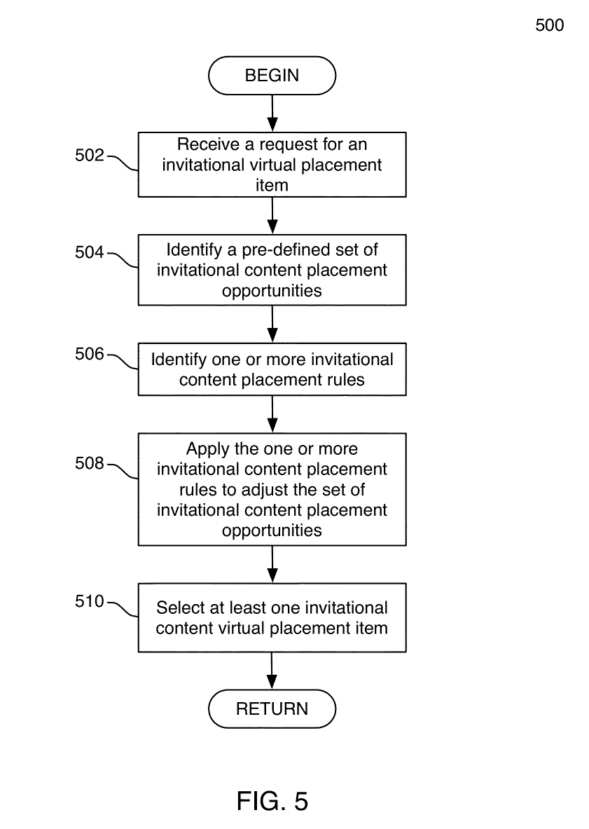

FIG. 5 is a flowchart illustrating steps in an exemplary method 500 for delivery invitational content for presentation in an interactive environment. For the sake of clarity, this method is discussed in terms of an exemplary system such as is shown in FIG. 1. Although, specific steps are shown in FIG. 5, in other embodiments a method can have more or less steps than shown.

At some point, the content delivery system 106 can receive a request for at least one invitational content virtual placement item (502) from a client device 102. The information included with the request can vary with the configuration of the system. In some cases, a request can include an interactive environment identifier and/or a position within the interactive environment. A request can also include user characteristics and/or other user data, such as an interaction history, which can be used by the content delivery system 106 to aid in selecting at least one invitational content item to delivery to the requesting client device 102.

In response to the request, the content delivery system 106 can identify a pre-defined set of invitational content placement opportunities (504) that correspond to a interactive environment rendered on the requesting client device 102. In some cases, the pre-defined set of invitational content placement opportunities can be defined by a developer of the virtual and can be stored in the content delivery system 106. However, the pre-defined set of placement opportunities can also be fetched from a content provider, such as primary content providers 109, or can be included with the request from the client device 102.

The content delivery system 106 can also identify one or more invitational content placement rules (506). In some cases, the placement rules can be specific to the interactive environment rendered on the requesting client device 102. However, one or more placement rules can also be universal placement rules that apply to any interactive environment.

After identifying both the pre-defined set of invitational content placement opportunities and one or more invitational content placement rules, the content delivery system can apply the one or more invitational content placement rules to adjust the set of placement opportunities (508). The rules can be applied in conjunction with other data, such as an interaction history, system data regarding booked campaigns, user profile data, etc. The result of applying the one or more invitational content placement rules can be to alter one or more properties of one or more placement opportunities or the set of placement opportunities. The properties can include the number of placement opportunities, the location of a placement opportunity, one or more placement characteristics specified in a placement opportunity, the duration of a placement opportunity, a cost associated with a placement opportunity, etc.

Once the set of placement opportunities has been adjusted, the content delivery system 106 can select at least one invitational content virtual placement item (510) to deliver to the requesting client device 102. In some cases, the content delivery system 106 can select at least one invitational content item for each placement opportunity in the set of placement opportunities. However, the content delivery system 106 can also be configured to select at least one invitational content virtual placement item for only a subset of the placement opportunities in the set of placement opportunities.

An invitational content virtual placement item can be selected for a placement opportunity based on the placement characteristics specified in the placement opportunity. The placement characteristics can include virtual placement item characteristics from one or more virtual placement item classification hierarchies. The content delivery system 106 can also be configured to select an invitational content virtual placement item based on other factors, such as target user characteristics, campaign goals, cost, etc.

In some cases, selecting an invitational content virtual placement item can include selecting an invitational content item and overlaying on a virtual placement item to generate an invitational content virtual placement item. However, an invitational content virtual placement item can also be an invitational content item that is designed to be overlaid on a virtual placement item on the client device 102, such as at the time the virtual placement item is rendered on the client device 102.

In some cases, the content delivery system 106 may not select an invitational content virtual placement item for each placement opportunity. In this case, a generic virtual placement item can be displayed at the placement opportunity or the interactive environment can be configured such that no virtual placement item is presented. In some configurations, the content delivery system 106 can deliver the generic virtual placement item along with any invitational content virtual placement items.

After selecting any invitational content virtual placement items and/or generic virtual placement items, the content delivery system 106 can deliver the selected virtual placement items to the requesting client device 106 and resume previous processing, which can include repeating method 500.

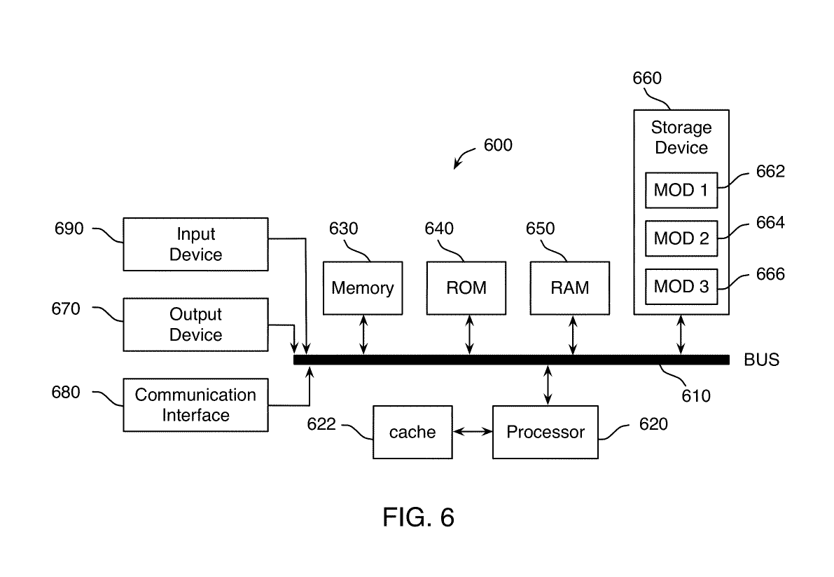

With reference to FIG. 6, an exemplary system 600 includes a general-purpose computing device 600, including a processing unit (CPU or processor) 620 and a system bus 610 that couples various system components including the system memory 630 such as read only memory (ROM) 640 and random access memory (RAM) 650 to the processor 620. The system 600 can include a cache 622 connected directly with, in close proximity to, or integrated as part of the processor 620. The system 600 copies data from the memory 630 and/or the storage device 660 to the cache for quick access by the processor 620. In this way, the cache provides a performance boost that avoids processor 620 delays while waiting for data. These and other modules can control or be configured to control the processor 620 to perform various actions. Other system memory 630 may be available for use as well. The memory 630 can include multiple different types of memory with different performance characteristics. It can be appreciated that the disclosure may operate on a computing device 600 with more than one processor 620 or on a group or cluster of computing devices networked together to provide greater processing capability. The processor 620 can include any general purpose processor and a hardware module or software module, such as module 1 662, module 2 664, and module 3 666 stored in storage device 660, configured to control the processor 620 as well as a special-purpose processor where software instructions are incorporated into the actual processor design. The processor 620 may essentially be a completely self-contained computing system, containing multiple cores or processors, a bus, memory controller, cache, etc. A multi-core processor may be symmetric or asymmetric.

The system bus 610 may be any of several types of bus structures including a memory bus or memory controller, a peripheral bus, and a local bus using any of a variety of bus architectures. A basic input/output (BIOS) stored in ROM 640 or the like, may provide the basic routine that helps to transfer information between elements within the computing device 600, such as during start-up. The computing device 600 further includes storage devices 660 such as a hard disk drive, a magnetic disk drive, an optical disk drive, tape drive or the like. The storage device 660 can include software modules 662, 664, 666 for controlling the processor 620. Other hardware or software modules are contemplated. The storage device 660 is connected to the system bus 610 by a drive interface. The drives and the associated computer readable storage media provide nonvolatile storage of computer readable instructions, data structures, program modules and other data for the computing device 600. In one aspect, a hardware module that performs a particular function includes the software component stored in a non-transitory computer-readable medium in connection with the necessary hardware components, such as the processor 620, bus 610, output device 670, and so forth, to carry out the function. The basic components are known to those of skill in the art and appropriate variations are contemplated depending on the type of device, such as whether the device 600 is a small, handheld computing device, a desktop computer, or a computer server.

Although the exemplary embodiment described herein employs the hard disk 660, it should be appreciated by those skilled in the art that other types of computer readable media which can store data that are accessible by a computer, such as magnetic cassettes, flash memory cards, digital versatile disks, cartridges, random access memories (RAMs) 650, read only memory (ROM) 640, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 600, an input device 690 represents any number of input mechanisms, such as a microphone for speech, a touch-sensitive screen for gesture or graphical input, keyboard, mouse, motion input, speech and so forth. An output device 670 can also be one or more of a number of output mechanisms known to those of skill in the art. In some instances, multimodal systems enable a user to provide multiple types of input to communicate with the computing device 600. The communications interface 680 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 620. The functions these blocks represent may be provided through the use of either shared or dedicated hardware, including, but not limited to, hardware capable of executing software and hardware, such as a processor 620, that is purpose-built to operate as an equivalent to software executing on a general purpose processor. For example the functions of one or more processors presented in FIG. 6 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 640 for storing software performing the operations discussed below, and random access memory (RAM) 650 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 600 shown in FIG. 6 can practice all or part of the recited methods, can be a part of the recited systems, and/or can operate according to instructions in the recited non-transitory computer-readable storage media. Such logical operations can be implemented as modules configured to control the processor 620 to perform particular functions according to the programming of the module. For example, FIG. 6 illustrates three modules Mod1 662, Mod2 664 and Mod3 666 which are modules configured to control the processor 620. These modules may be stored on the storage device 660 and loaded into RAM 650 or memory 630 at runtime or may be stored as would be known in the art in other computer-readable memory locations.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A computer-implemented method comprising:
determining a set of invitational content placement opportunities within a view of an interactive environment based on one or more invitational content placement rules related to the interactive environment, wherein each placement opportunity in the set of invitational content placement opportunities specifies one or more placement characteristics for a virtual placement item, the one or more placement characteristics including at least one virtual placement item characteristic from one or more virtual placement item classification hierarchies, each virtual placement item classification hierarchy defining a hierarchical relationship between a plurality of virtual placement item characteristics, wherein a characteristic lower in the virtual placement item classification hierarchy has a greater specificity than an item higher in the virtual placement item classification hierarchy on the same branch; and
selecting, via a processor, at least one invitational content virtual placement item, the at least one invitational content virtual placement item selected for at least one placement opportunity from the set of invitational content placement opportunities, the selecting satisfying the one or more placement characteristics specified in the at least one placement opportunity.

2. The computer-implemented method of claim 1, wherein determining a set of invitational content placement opportunities within an interactive environment based on one or more invitational content placement rules comprises:
identifying a pre-defined set of invitational content placement opportunities; and
applying the set of invitational content placement rules to adjust the set of invitational content placement opportunities.

3. The computer-implemented method of claim 1, wherein each invitational content placement opportunity is assigned a cost, the cost based at least in part on a virtual placement item characteristic specified for the invitational content placement opportunity.

4. The computer-implemented method of claim 3, wherein the price is lower when the invitational content placement opportunity specifies a virtual placement item characteristic lower in the classification hierarchy.

5. The computer-implemented method of claim 1, wherein at least one of the one or more virtual placement item classification hierarchies is specific to the interactive environment.

6. A system comprising:
a processor;
a first module configured to control the processor to receive a request for at least one invitational content virtual placement item for a view in an electronic environment;
a second module configured to control the processor to identify a pre-defined set of invitational content virtual placement item placement opportunities in the view of the electronic environment and adjust the set of invitational content virtual placement item placement opportunities based on one or more invitational content placement rules identified for the view in the electronic environment, the adjusting occurring in real-time in response to the request for the at least one invitational content virtual placement item; and
a third module configured to control the processor to select at least one invitational content virtual placement item for at least one placement opportunity in the set of invitational content virtual placement item placement opportunities.

7. The system of claim 6, wherein adjusting the set of invitational content virtual placement item placement opportunities increases a number of placement opportunities in the set of invitational content virtual placement item placement opportunities.

8. The system of claim 7, wherein increasing a number of placement opportunities corresponds to increasing a number of virtual placement items presented in the electronic environment.

9. The system of claim 6, wherein at least one of the one or more invitational content placement rules specifies increasing a number of placement opportunities in the set of invitational content placement opportunities in response to detecting an increase in users engaged with the electronic environment.

10. The system of claim 6, wherein at least one of the one or more invitational content placement rules specifies increasing a number of placement opportunities in the set of invitational content placement opportunities in response to detecting a number of users engaged with the electronic environment is greater than a threshold number of users.

11. The system of claim 6, wherein each invitational content virtual placement item placement opportunity specifies one or more placement characteristics.

12. The system of claim 6, wherein the one or more placement characteristics include at least one of virtual placement item characteristics or user characteristics.

13. The system of claim 6, wherein the at least one virtual placement item characteristic is from a virtual placement item classification hierarchy, the virtual placement item classification hierarchy defining a hierarchical relationship between a plurality of virtual placement item characteristics, wherein a characteristic lower in the virtual placement item classification hierarchy has a greater specificity than an item higher in the virtual placement item classification hierarchy on the same branch.

14. A manufacture comprising:
a non-transitory computer-readable storage medium, and
a computer executable instruction stored on the non-transitory computer-readable storage medium which, when executed by a computing device, causes the computing device to perform a method comprising:
identifying a pre-defined set of invitational content placement opportunities in a view in an interactive environment, each placement opportunity in the invitational content placement opportunities specifying one or more placement characteristics for a virtual placement item, the one or more placement characteristics included in a virtual placement item classification hierarchy;
adjusting the set of invitational content placement opportunities based on one or more invitational content placement rules identified for the interactive environment, the adjusting occurring in real-time in response to a request for at least one invitational content virtual placement item; and
selecting at least one invitational content virtual placement item for presentation in the interactive environment, the at least one invitational content virtual placement item selected for at least one placement opportunity from the adjusted set of invitational content placement opportunities.

15. The manufacture of claim 14, wherein the adjusting occurs during execution of the interactive environment.

16. The manufacture of claim 14, wherein at least one of the one or more invitational content placement rules specifies adjusting the set of invitational content placement opportunities based on an interaction history for the interactive environment.

17. The manufacture of claim 16, wherein the interaction history includes a navigation history across users of the interactive environment.

18. The manufacture of claim 16, wherein the interaction history is specific to an instantiation of the interactive environment.

19. A computer-implemented method comprising:
rendering, via a processor, an interactive environment;
detecting an invitational content triggering event for a view in the interactive environment;
in response to detecting the invitational content triggering event, identifying an invitational content placement opportunity within the view of the interactive environment, the invitational content placement opportunity specifying an index in a virtual placement item classification hierarchy, the virtual placement item classification hierarchy defining a hierarchical relationship between a plurality of virtual placement item characteristics, wherein a characteristic lower in the virtual placement item classification hierarchy has a greater specificity than an item higher in the virtual placement item classification hierarchy on the same branch; and
presenting in the identified invitational content placement opportunity an invitational content item in conjunction with a virtual placement item, the invitational content item selected based at least in part on a virtual placement item characteristic at the index in the virtual placement item classification hierarchy.

20. The computer-implemented method of claim 19, wherein the invitational content placement opportunity further specifies at least one of a duration to display the invitational content item or one or more target user characteristics.

21. The computer-implemented method of claim 19, wherein the invitational content item is further selected based on one or more target user characteristics specified in the placement opportunity.

22. A system comprising:
a server comprising a processor, the server configured to serve invitational content virtual placement items;
a first module configured to control the server to receive a request from a client device for at least one invitational content virtual placement item, the request specifying a view in an interactive environment;
a second module configured to control the server to apply one or more invitational content placement rules to adjust a set of invitational content placement opportunities within the view in the interactive environment, the adjusting occurring in real-time in response to the request for the at least one invitational content virtual placement item; and
a third module configured to control the server to deliver at least one invitational content item for at least one placement opportunity in the set of invitational content placement opportunities, the at least one invitational content item to be rendered as an invitational content virtual placement item in the interactive environment on the client device.

23. The system of claim 22, wherein each placement opportunity in the set of invitational content placement opportunities specifies one or more placement characteristics, and wherein the third module is further configured to deliver a generic virtual placement item for a placement opportunity when an invitational content virtual placement item is unavailable or fails to satisfy the specified one or more placement characteristics.

24. The system of claim 22, wherein the at least one invitational content item is to be rendered by overlaying the invitational content item on a virtual placement item.

25. The system of claim 22, wherein the at least one invitational content item is a virtual placement item provided by an invitational content provider.
